(19) United States
(12) Patent Application Publication
(10) Pub. No.: US 2012/0264398 A1
(43) Pub. Date: Oct. 18, 2012

(54) ELECTRONIC DEVICE AND UNLOCKING METHOD THEREOF

(75) Inventors: BIN LIU, Shenzhen City (CN); WEN-WU WANG, Shenzhen City (CN); WEN-DONG LUO, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/163,697

(22) Filed: Jun. 19, 2011

(30) Foreign Application Priority Data
Apr. 14, 2011 (CN) 201110093307.7

(51) Int. Cl. H04M 3/16

(52) U.S. Cl. 455/410

(57) ABSTRACT

An electronic device includes a detecting unit, a proximity sensor and an unlocking unit. The detecting unit is used for detecting whether the electronic device is in a standby state, and generating a first signal when it is detected that the electronic device is in the standby state. The proximity sensor is used for sensing whether a person is proximate to the electronic device, and generates a second signal when it is determined the person is proximate to the electronic device. The unlocking unit is used for unlocking the electronic device when the first and second signals are generated within the same period of time.

### BACKGROUND

1. Technical Field

The present disclosure relates to electronic devices; and particularly to an unlocking method used by an electronic device.

2. Description of Related Art

A keyboard of a cell phone may be unlocked by pressing a key combinations or sliding a key arranged on a sidewall of the cell phone. The need for the user to physically operate the key(s) arranged on the cell phone is not the optimal ergonomic arrangement.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a schematic view of an electronic device in accordance with one embodiment.

FIG. 2 is a block diagram of the electronic device in FIG. 1 in accordance with one embodiment.

FIG. 3 is a flow chart of an unlocking method in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

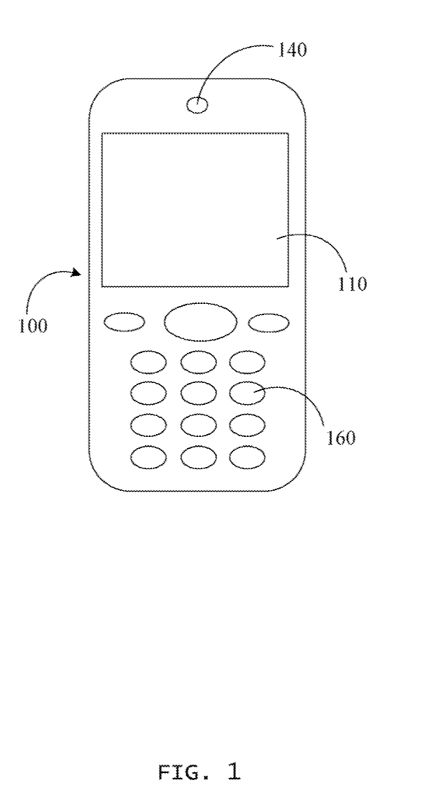

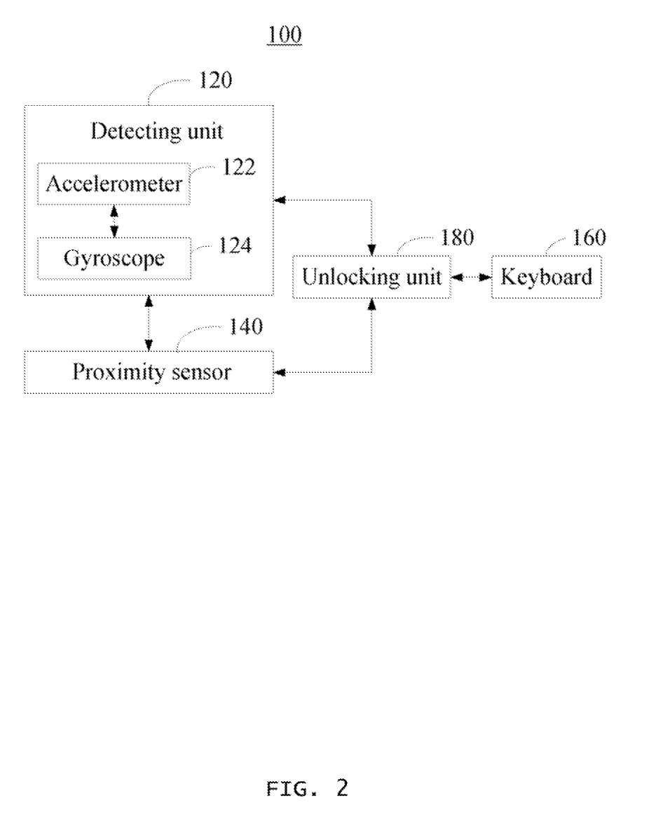

Referring to FIGS. 1 and 2, an electronic device 100 includes a display screen 110, a detecting unit 120, a proximity sensor 140, a keyboard 160 and an unlocking unit 180. In the embodiment, the electronic device 100 is a cell phone. The display screen 110, the proximity sensor 140, and the keyboard 160 are disposed on the same surface of the electronic device 100, such as a top surface.

The detecting unit 120 is used for detecting whether the electronic device 100 is in a standby state, and generating a first signal when it is detected that the electronic device 100 is in the standby state. The standby state requires that the electronic device 100 be moved to a required orientation, either slanted or flat or upright. The required orientation is determined by the user. In the embodiment, the required orientation is slanted.

The detecting unit 120 includes an accelerometer 122 and a gyroscope 124. The accelerometer 122 is used for sensing whether the electronic device 100 is in motion. The gyroscope 124 is used for detecting whether the electronic device 100 is in the required orientation.

The proximity sensor 140 is used for sensing whether a person is proximate to the electronic device 100, and generating a second signal when it is determined the person is proximate. In the embodiment, the proximity sensor 140 is an infrared sensor. When the proximity sensor 140 detects that the distance between an object such as a human being and the electronic device 100 is within a certain range, it is determined that a person is proximate to the electronic device 100. In the embodiment, the certain range is 20 cm to 80 cm.

The unlocking unit 180 is used to unlock the electronic device 100 when the first and second signals are generated in the same period of time. In the embodiment, the unlocking unit 180 is used to unlock the keyboard 160 of the electronic device 100. The unlocking unit 180 also can be used to unlock other components of the electronic device 100. The period of time is determined by the user. In the embodiment, the period of time is one minute, that is, the unlocking unit 180 unlocks the electronic device 100 when the first and second signals are generated within one minute.

Before using the electronic device 100, a user often positions the electronic device 100 so that the electronic device 100 is in the standby state and proximate to the user, for example, a cell phone is often placed close to the user, and then slanted such that the display screen 110 and the keyboard 160 face the user. As such, the unlocking of the electronic device 100 can be achieved with no inconvenience at all.

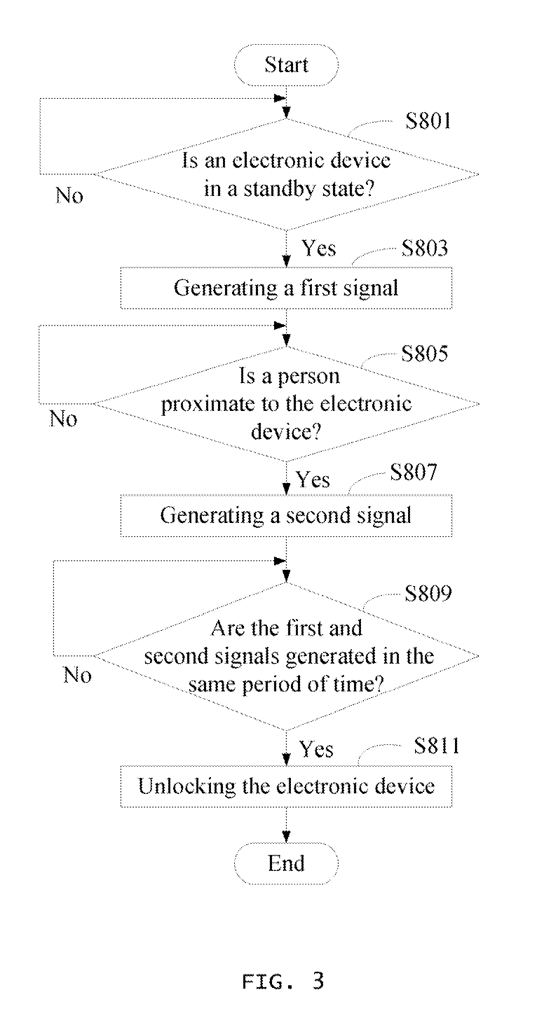

Referring to FIG. 3, an unlocking method used by an electronic device is provided. The unlocking method includes the following steps. The electronic device may be a cell phone.

In step S801, detecting whether the electronic device is in a standby state. If it is detected that the electronic device is in the standby state, step S803 is implemented. If it is detected that the electronic device is not in the standby state, step S801 is repeated. The standby state requires that the electronic device be moved to a required orientation, either slanted or flat or upright. The required orientation is determined by the user. In the embodiment, the required orientation is slanted.

In step S803, generating a first signal.

In step S805, determining whether a person is proximate to the electronic device. If it is determined that the person is proximate to the electronic device, step S807 is implemented. If it is determined that no person is proximate to the electronic device, step S805 is repeated. In the embodiment, the electronic device includes an infrared sensor for determining whether a person is proximate to the electronic device. If the infrared sensor detects that the distance between an object such as a human being and the electronic device within a certain range, it is determined that a person is proximate to the electronic device. In the embodiment, the certain range is 20 cm to 80 cm.

In step S807, generating a second signal.

In step S809, determining whether the first and second signals are generated in the same period of time. If it is determined that the first and second signals are generated in the same period of time, step S811 is implemented. If it is determined that the first and second signals are not generated in the same period of time, step S809 is repeated. The period of time is determined by the user. In the embodiment, the period of time is one minute.

In step S811, unlocking the electronic device such that a user can use the electronic device.

Before using the electronic device, a user often positions the electronic device so that the electronic device is in the standby state and proximate to the user, for example, a cell phone is often placed close to the user, and then slanted such that a display screen thereof faces the user. As such, the unlocking of the electronic device can be achieved with no inconvenience at all.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

1. An electronic device, comprising:
a detecting unit for detecting whether the electronic device is in a standby state, and generating a first signal when it is detected that the electronic device is in the standby state;
a proximity sensor sensing whether a person is proximate to the electronic device, and generating a second signal when it is determined the person is proximate to the electronic device; and
an unlocking unit for unlocking the electronic device when the first and second signals are generated in the same period of time.

2. The electronic device according to claim 1, wherein the standby state requires that the electronic device be moved to a required orientation, and the detecting unit determines that the electronic device is in a standby state based on the determination that the electronic device is moved to the required orientation.

3. The electronic device according to claim 2, wherein the electronic device is a cell phone, and the required orientation is slanted.

4. The electronic device according to claim 1, wherein when the proximity sensor detects the distance between an object and the electronic device within a certain range, it is determined that a person is proximate to the electronic device.

5. The electronic device according to claim 4, wherein the certain range is 20 cm to 80 cm.

6. The electronic device according to claim 2, wherein the detecting unit comprises an accelerometer for sensing whether the electronic device is in motion, and a gyroscope for detecting whether the electronic device is moved to the required orientation.

7. The electronic device according to claim 1, wherein the period of time is one minute.

8. An unlocking method used by an electronic device, comprising:
detecting whether the electronic device is in a standby state;
if it is detected that the electronic device is in the standby state, generating a first signal;
determining whether a person is proximate to the electronic device;
if it is determined that the person is proximate to the electronic device, generating a second signal;
determining whether the first and second signals are generated in the same period of time; and
if it is determined that the first and second signals are generated in the same period of time, unlocking the electronic device.

9. The unlocking method according to claim 8, wherein the standby state requires that the electronic device be moved to a required orientation, and the electronic device is determined to be in the standby state when the electronic device is detected to be moved to the required orientation.

10. The unlocking method according to claim 9, wherein the electronic device is a cell phone, and the required orientation is slanted.

11. The unlocking method according to claim 8, further comprising:
if it is detected that the electronic device is not in the standby state, the step of detecting whether the electronic device is in a standby state is further implemented.

12. The unlocking method according to claim 8, further comprising:
if it is determined that no person is proximate to the electronic device, the step of determining whether a person is proximate to the electronic device is further implemented.

13. The unlocking method according to claim 8, further comprising:
if it is determined that the first and second signals are not generated in the same period of time, the step of determining whether the first and second signals are generated in the same period of time is further implemented.

14. The unlocking method according to claim 8, wherein the period of time is one minute.

15. The unlocking method according to claim 8, wherein whether a person is proximate to the electronic device is determined by detecting whether the distance between an object and the electronic device within a certain range; it is determined that a person is proximate to the electronic device when the distance between the object and the electronic device is within the certain range.

16. The unlocking method according to claim 15, wherein the certain range is 20 cm to 80 cm.
